(19) United States
(12) Patent Application Publication
(10) Pub. No.: US 2005/0231529 A1
(43) Pub. Date: Oct. 20, 2005

(54) Method and system for displaying information and vehicle infotainment system

(76) Inventors: Volker Skwarek, Bad Salzdetfurth (DE); Ulrich Kersken, Diekholzen (DE)

Correspondence Address: KENYON & KENYON, ONE BROADWAY, NEW YORK, NY, 10004, US

(21) Appl. No.: 10/499,784

(22) PCT Filed: Dec. 17, 2002
(86) PCT No.: PCT/DE02/04615

§ 371 Date: Jun. 10, 2005

(30) Foreign Application Priority Data
Dec. 20, 2001 (DE) 10162653.3

(51) Int. Cl. G09G 5/00

(52) U.S. Cl. 345/619

(57) ABSTRACT

In a system and a method for displaying information on a display controlled by a display controller, display controller includes a memory and a program. Subjects having corresponding priorities are stored in memory. A data source, e.g., telephone, radio or navigation system is unambiguously assigned to each subject. The highest-priority subject is displayed on main display window and the other low-priority subjects are displayed on secondary display windows and. If there is a change in information in one of the secondary display windows, the particular subject is displayed at least temporarily on main display window.

### FIELD OF THE INVENTION

The present invention relates to a method and system for displaying information and a vehicle infotainment system for motor vehicles.

### BACKGROUND INFORMATION

Certain driver information systems for displaying information and for entertainment are believed to be conventional. With conventional systems, the display is within defined display screens and sequences. The content and the type of display of the information presented in the window are fixed.

Such driver information systems are used for displaying vehicle information supplied by an on-board computer, for a navigation system or as a display for an audio system, e.g., for a Digital Audio Broadcast system. Similar systems are described in Japanese Published Patent Application No. 9-062475, Japanese Published Patent Application No. 7-271824 and International Published Patent Application No. WO 99/23454.

A disadvantage of such conventional systems is that the display of information assigned to various subject areas follows rigid specifications. This results, for example, in the driver information system being unable to display new modules or information, e.g., from a PDA in a suitably equipped vehicle, until new HMI software has been installed. Information from the on-board computer, the navigation system, the audio system and the telephone is not displayed according to its importance at the moment.

### SUMMARY

It is an aspect of the present invention to provide a system and method for displaying information in a motor vehicle.

An example embodiment of the present invention may allow simultaneous display of information assigned to different subjects in different windows of a single display. This information may be scaled so that the driver's attention is diverted to the most relevant information in each case. This may provide that the risk of an accident is greatly reduced because the driver is able to concentrate on precisely the most relevant information.

Due to the scaling, the display of information is adapted to the size and shape of the window. If the size of the window is not sufficient, the information is reduced, e.g., by omitting words, using abbreviations or even icons or symbols in different colors or even by strictly acoustic output, etc.

According to an example embodiment of the present invention, scaling of information is implemented in the data sources, e.g., in a navigation system, cell phone, audio system, Internet system, etc., which is connected to this system, for example, the scaling being performed as a function of the available window size.

According to an example embodiment of the present invention, the window size may also be changed automatically by the data source. Window size may be reduced to provide more display space for other data sources.

According to an example embodiment of the present invention, a data source defines other subwindows in its window and makes them available to other data sources for display.

In an example embodiment of the present invention, the data source queries or assigns subwindows to other data sources or contents in a controlled manner. For example, the data source “navigation” assigns one window to the data source “navigation” and another small window to “position finding,” to show the quality of GPS reception.

According to an example embodiment of the present invention, the user has an opportunity to modify the “factory settings” and to select from various subjects and assign different priorities to the subjects. In this manner, the user is able to determine the combination of information which is most relevant for him.

According to an example embodiment of the present invention, there is a change in the assignment from one subject of a secondary display window to the main display window when the information of the subject of the secondary display window changes. Before this change in assignment, the secondary display window may first be emphasized visually, e.g., by color or by flashing, to attract the driver's attention to the secondary display window or this may be done acoustically. In addition, the change may also depend on whether the information in the secondary window has a higher priority and/or importance than the information in the main window.

If the driver confirms within a predetermined period of time that he has taken cognizance of the altered information of the secondary display window, the visual emphasis is terminated and there is no change in the assignment. However, if the driver does not provide such a confirmation, the change in assignment is made automatically by the system so that the information displayed for the driver previously in the secondary display window is now presented in the main display window in order to attract the driver's attention to the altered information. After the driver has confirmed the altered information displayed in the main display window, the change in assignment may be cancelled again and the initial state may be restored.

When there is a change in assignment, e.g., when the information previously illustrated in a secondary display window is now being displayed in the main display window, the scaling of the information on this subject may be cancelled, e.g., all available information is retrievable by the corresponding data source for display on the display window without scaling.

According to an example embodiment of the present invention, the main display window has a 4:3 format while the secondary display window is displayed in a secondary area. The total area, composed of the main area for the main display window and the secondary area, then may have an aspect ratio of 16:9. This may provide that existing data sources which deliver display data for display on a 4:3 display may continue to use the 16:9 aspect ratio with no change.

Example embodiments of the present invention are explained in greater detail below with reference to the appended Figures.

### BRIEF DESCRIPTION OF THE DRAWINGS

FIG. 1 illustrates a block diagram of an example embodiment of a system according to the present invention for the display of information.

FIG. 2 illustrates a flow chart of an example embodiment of the method according to the present invention for displaying information.

FIG. 3 illustrates an example embodiment of a method according to the present invention in which there is a change in the assignment of data sources to main display windows and secondary display windows.

FIG. 4 illustrates an example embodiment of a method according to the present invention in which a visual emphasis is additionally provided before the change in the assignment.

### DETAILED DESCRIPTION

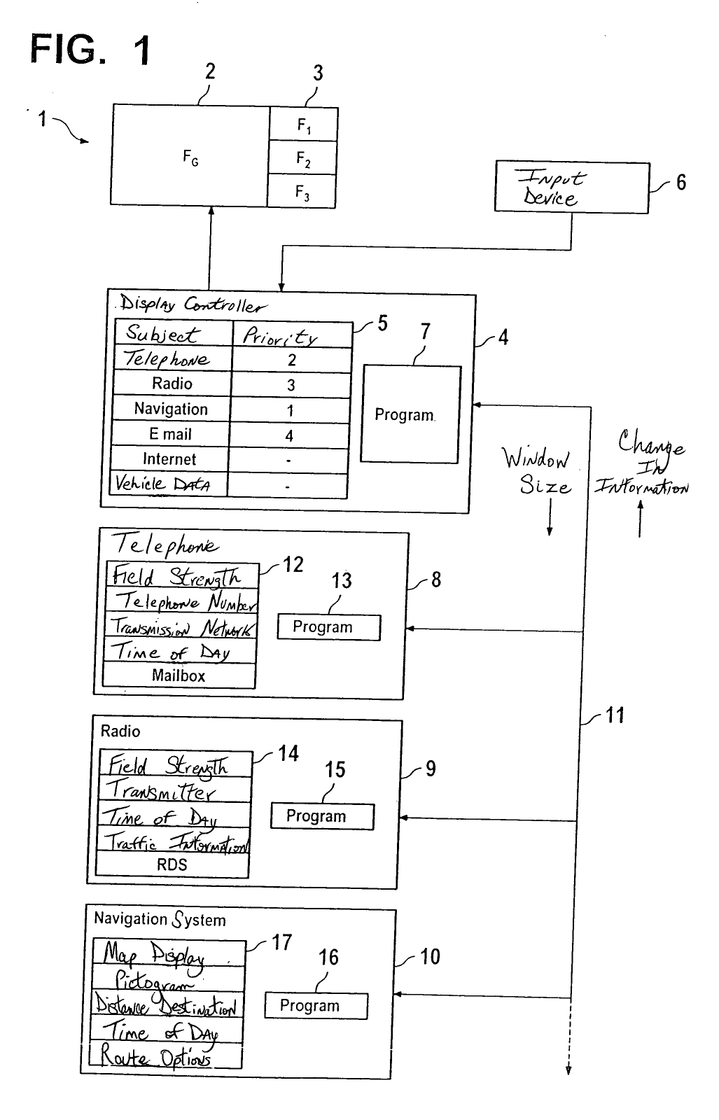

FIG. 1 illustrates a block diagram of a system for displaying information in a vehicle, e.g., in a motor vehicle. This system according to FIG. 1 may be, for example, an infotainment system, for displaying information and entertainment data.

The system in FIG. 1 includes a display 1. Display 1 is for displaying a main display window F_{G} on a main area 2 of display 1. Furthermore, display 1 includes a secondary area 3 for displaying one or more secondary display windows—in the example illustrated in FIG. 1, these are secondary display windows F₁, F₂ and F₃.

Main area 2 may have an aspect ratio of 4:3, and the total area resulting from main area 2 and secondary area 3 may have an aspect ratio of 16:9.

Display controller 4 is connected to display 1. Display controller 4 supplies the image data illustrated on display 1.

Display controller 4 includes a memory 5 for storing a list of subjects and the priorities assigned to the particular subjects. In the example illustrated here, these are the subjects: “telephone,” “radio,” “navigation,” “email,” “Internet” and “vehicle data.” From these subjects, a user may select one or more subjects via an input device 6 and may assign priorities to the subjects. In the example illustrated here, the user has selected the subjects “navigation,” “telephone,” “radio” and “email” in this order of priorities via input device 6.

Accordingly the highest priority “1” is assigned to the subject “navigation” and the lowest priority “4” is assigned to the subject “email.” The subjects “Internet” and “vehicle data” are not selected by the user. A selection of subjects with the corresponding priorities may be made at the factory, so the user need not necessarily make his own selection.

Furthermore, display controller 4 includes a program 7. Program 7 includes various program modules for the particular functions of display controller 4, e.g., for generating image data and other functions which are described below.

The system illustrated in FIG. 1 also includes a number of data sources, e.g., a telephone 8, a radio 9 and a navigation system 10 as well as additional data sources may include, for example, email access and Internet access, an on-board computer for supplying the vehicle data and a radio receiver.

Each data source 8, 9, 10, etc. is connected to display controller 4 via a bus 11. Bus 11 may be a databus of the type conventionally used in motor vehicles, e.g., a MOST, CAN or FireWire databus or a wireless connection such as Bluetooth.

When the system is initialized according to FIG. 1, the subject “navigation” having a priority of “1,” e.g., the highest priority, is assigned by program 7 to main display window F_{G}. In contrast, the low-priority subjects “telephone,” “radio” and “email” are assigned by program 7 to secondary display windows F₁, F₂ and F₃, but the subjects “Internet” and “vehicle data” are not assigned to any secondary display windows because these were not selected previously by the user via input device 6.

The three low-priority subjects yield a division of secondary area 3 into three secondary display windows of equal size. This division of secondary area 3 is also automatically computed by program 7. The resulting window size is relayed by program 7 to the data sources assigned to the low-priority subjects via a message over bus 11. Accordingly, telephone 8, radio 9 and the email access receive such a message which includes the window size of the secondary display window.

Various types of information 12 are contained in telephone 8, e.g., the field strength, the transmission network, the time of day, the telephone number of a caller, the time of day of the cal, the telephone number of a caller and the mailbox functions of telephone 8, e.g., an indicator that there is a message in the mailbox. From this information and additional information present in telephone 8, program 13 of telephone 8 selects the most relevant information, which is displayed in a legible form for the driver in the available area of the secondary display window assigned to telephone 8.

To this extent, the information present in telephone 8 is scaled by program 13 to perform information filtering. For example, program 13 will mask out the information “field strength,” “transmission network” and “time of day” as well as other information to select only the most relevant information, namely with regard to an incoming telephone call and a message in the mailbox.

Corresponding information 14 is present in radio 9, namely “field strength,” “sender,” “time of day,” “traffic information” and “RDS” as well as other information. This is in turn scaled by a program 15 which corresponds to program 13. For example, program 15 selects only the sender display from information 14. A corresponding program is also present in the email access and in the Internet access as well as in the on-board computer.

Navigation system 10 includes a program 16 for scaling information 17 of navigation system 10. Information 17 of navigation system 10 includes, for example, a map display of navigation information, a pictogram-type display of the navigation information, information about the distance to the destination, the estimated time of arrival, and route options. In the example illustrated here, program 16 is not activated because main window F_{G} is available to the navigation system.

Accordingly, navigation system 10 also supplies information for the display in 4:3 format on main area 2. However, if navigation system 10 receives such a message with the window size of a secondary display window at a later point in time, program 16 is activated to perform scaling of information 17. For example, program 16 will then select the space-saving pictogram-like display of the route guidance information and will mask out other types of information 17.

If the information in one of the low-priority data sources, e.g., telephone 8 or radio 9, for example, has changed, this has the following effects: for example, if a call arrives on telephone 8, a message for display controller 4 is generated by program 13 due to the change in this information 12 and is transmitted over bus 11 to display controller 4.

Reception of this message in display controller 4 has the result that there is a change in the assignment of telephone 8 to a display area. Namely telephone 8 is at least temporarily assigned by program 7 to main display window F_{G} so that the data supplied by telephone 8 is displayed in main display window F_{G}. In contrast, the data supplied by navigation system 10 is assigned to secondary display window F₁ which had previously displayed the data of telephone 8.

For scaling the data of navigation system 10, program 7 generates a corresponding message including the window size of secondary display window F₁ which is transmitted by the display controller over bus 11 to navigation system 10. Program 16 of navigation system 10 then performs a corresponding scaling of information 17 and sends the scaled information over bus 11 to display controller 4, a display of scaled information of navigation system 10 being generated on secondary display window F₁ by program 7.

Before the change in the assignment occurs, program 7 may first create a visual emphasis on secondary display window F₁ assigned to telephone 8, e.g., by color emphasis on secondary display window F₁, by flashing, by a change in typeface, by a change in layout of the secondary display window, etc. If the user, e.g., the driver, confirms that this information has been noted by making a corresponding input via input device 6 within a predetermined period of time after the start of the visual emphasis, then the visual emphasis is terminated.

If this is not the case, then the change in assignment occurs in such a manner that telephone 8 is assigned to main display window F_{G} and navigation system 10 is assigned to secondary display window F₁. Again after a predetermined period of time or after the user has confirmed that he has seen this information, display controller 4 returns to the initial state. To do so, it may be necessary for a message to be sent again at least to navigation system 10 to reverse the scaling of the information supplied by navigation system 10.

Display 1 may be configured as a touch screen so that the user may make entries directly via display 1. Alternatively, a keyboard, for example, or a tactile device, e.g., a joystick, etc., may be provided as the input device.

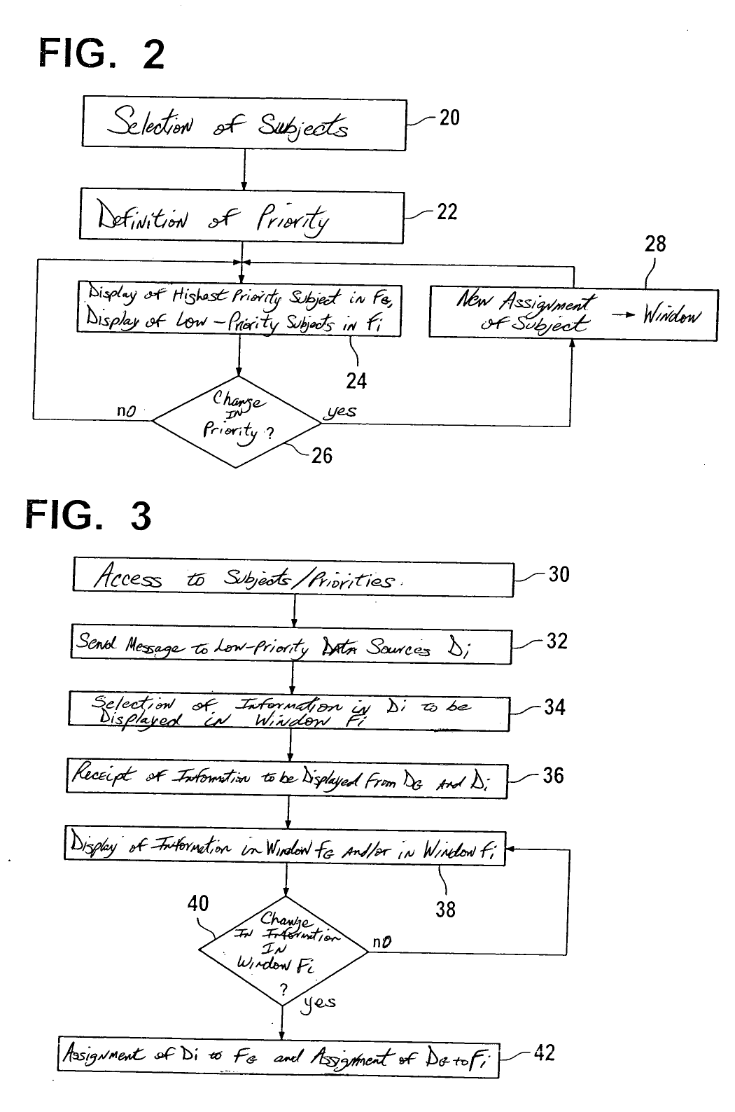

FIG. 2 illustrates an example embodiment of the method according to the present invention for displaying information, e.g., by a device such as that illustrated in FIG. 1.

In step 20, first the subjects are selected by the user. Alternatively, the selection of subjects may also be preselected by the system. Furthermore, the selection of subjects may also be made automatically by a driver assistance system, each based on the prevailing driving situation.

In step 22, the priorities of the subjects are defined. This definition may also be entered by the user or it may be predetermined as fixed information. The priorities may also be defined automatically by the driver assistance system depending on the prevailing driving situation.

In step 24 the highest-priority subject is then displayed in a main display window F_{G}. In contrast, the low-priority subjects of different priorities are displayed in secondary display windows Fᵢ. The secondary display windows each have the same size or they may also have different sizes, depending on the priority of the particular low-priority subject.

In step 26, the system checks on whether there has been a change in priority of the subjects. If the information of a low-priority subject changes, its priority is elevated. To do so, the subject is assigned to main display window F_{G} in step 28, for example, so that it is displayed in full size. This new assignment may be temporary, e.g., for a predetermined period of time or until confirmation is entered by the driver.

If the check in step 26 does not result in a change in priority, then the display remains unchanged in step 24.

FIG. 3 illustrates an example embodiment of a method according to the present invention.

In step 30, the subjects to be displayed are accessed with the particular assigned priorities. Each subject is assigned a certain data source D in the system, e.g., by stating a corresponding address in the memory of the display controller (see memory 5 of display controller 4 in FIG. 1).

In step 32, messages are automatically sent to all data sources Dᵢ which are assigned to low-priority subjects. Each message includes information to indicate the window size of the secondary display window in which the particular data source is to be displayed.

In step 34 the information to be displayed, e.g., secondary display window Fᵢ, is selected in each data source Dᵢ assigned to a low-priority subject. For selection of the information, a program or a list is used, for example, containing the data sources for selection of the most important information in the particular data source Dᵢ. This selection of information according to importance with respect to the available window size of the secondary display window is also referred to as scaling of information.

In step 36, for example, the information to be displayed by the display controller (see display controller 4 in FIG. 1) is received from the data sources, e.g., from data source D_{G} of the highest priority subject and the other data sources Dᵢ which are assigned to low-priority subjects.

The particular information is then displayed on a display (see display 1 in FIG. 1) in various windows. The information supplied by data source D_{G} assigned to the highest priority subject is displayed in main display window F_{G} and the information supplied by data sources Dᵢ assigned to low-priority subjects is displayed in secondary display windows Fᵢ in step 38.

In step 40 a check is performed to determine whether information in one of windows Fᵢ has changed. If this is not the case, the display then remains unchanged in step 38. However, if the information has changed, then in step 42 there is at least a temporary change in the assignments of data sources Dₖ whose information has changed to main display window F_{G} and at least a temporary assignment of data source D_{G}, which is assigned to the highest priority subject, to secondary display window Fₖ, e.g., the assignment of data sources Dₖ whose information has changed and the assignment of data source D_{G} which is assigned to the highest priority subject to the display windows are switched at least temporarily.

The case may also occur that the information of several data sources assigned to low-priority subjects may change essentially simultaneously. In this case, the highest priority of the low-priority subjects whose information has changed is selected by the system and the particular data source is assigned to the main display window. This may occur temporarily so that after a predetermined period of time or after confirmation is entered by the driver, the low-priority subject having the next lower priority whose information has also changed is assigned to the main display window until all the low priority subjects whose information has changed have been processed by successive assignment to the main display window.

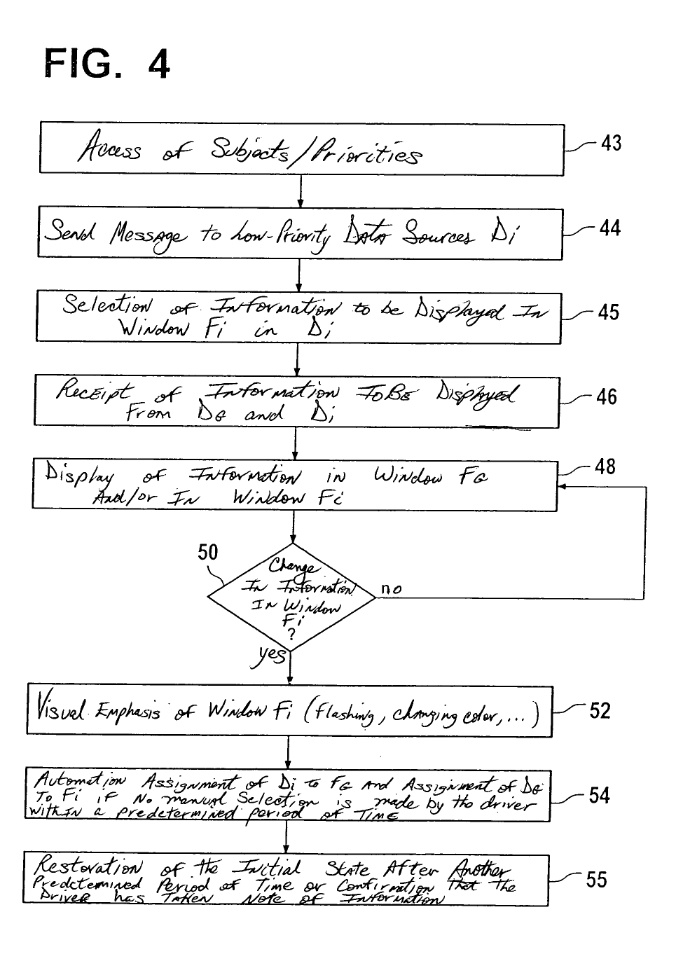

FIG. 4 illustrates an example embodiment of the method according to the present invention. Steps 43 to 50 of the method of FIG. 4 correspond to steps 30 to 40 of the example embodiment of FIG. 3. In contrast with the example embodiment of FIG. 3, there is no change in assignment in step 52, but instead first the particular window Fᵢ whose low-priority subject has a change in information is emphasized. This emphasis may be acoustic or visual, e.g., by flashing, by a change in color or by a change in typeface in window Fᵢ.

Within a predetermined period of time, a user, e.g., the driver, may confirm that he has taken note of the change in information in window Fᵢ. If such a confirmation does not occur within the predetermined period of time, then the assignment of data source Dᵢ to window Fᵢ is cancelled at least temporarily and data source Dᵢ is reassigned to main display window F_{G}. Accordingly, the highest priority subject having data source D_{G} is assigned at least temporarily to secondary display window Fᵢ. In this manner the low-priority subject whose information has changed is displayed at least temporarily in the main display window while the highest priority subject is displayed in a secondary display window. This occurs in step 54.

In step 55 the initial state of the display is restored either after a predetermined period of time or after confirmation that the driver has taken note of the change in information has been noticed by the driver.

LIST OF REFERENCE NOTATION

| | |
|---|---|
| display | 1 |
| main area | 2 |
| secondary area | 3 |
| display controller | 4 |
| memory | 5 |
| input device | 6 |
| program | 7 |
| telephone | 8 |
| radio | 9 |
| navigation system | 10 |
| bus | 11 |
| information | 12 |
| program | 13 |
| information | 14 |
| program | 15 |
| program | 16 |
| information | 17 |
| step | 20 |
| step | 22 |
| step | 24 |
| step | 26 |
| step | 28 |
| step | 30 |
| step | 32 |
| step | 34 |
| step | 36 |
| step | 38 |
| step | 40 |
| step | 42 |
| step | 43 |
| step | 44 |
| step | 45 |
| step | 46 |
| step | 48 |
| step | 50 |
| step | 52 |
| step | 54 |
| step | 55 |

1-28. (canceled)

29. A system for displaying information in a motor vehicle, comprising:
a display device configured to display information assigned to subjects in a main display window and in at least one secondary display window;
an storage device configured to store the subjects and an assignment of a highest priority to one of the subjects; and
an arrangement configured to generate a display on the display device to display information assigned to a highest-priority subject in the main display window and to display information assigned to a low-priority subject in one of the secondary display windows.

30. The system of claim 29, further comprising an input device configured to at least one of (a) input and (b) select subjects from the storage device at least of the highest priority.

31. The system of claim 30, wherein the display device includes a touch screen configured to implement the input device.

32. The system of claim 30, wherein the input device includes a graphic user interface.

33. The system of claim 29, wherein the display device includes:
a main display area in a 4:3 format configured to display the main display window; and
a secondary display area configured to display the secondary display window; and
wherein a total area formed by the main display area and the secondary display area is in a 16:9 format.

34. The system of claim 33, wherein the secondary display window has a predetermined size.

35. The system of claim 34, wherein the size of the secondary display window corresponds to an available secondary display area divided by a number of the secondary display windows.

36. The system of claim 34, wherein the size is independently adjustable by a data source.

37. The system of claim 29, wherein a data source is configured to define additional subwindows in a respective window and to make other data sources available for display.

38. The system of claim 37, wherein the data source is configured to (a) one of obtain subwindows of other data sources and (b) assign the subwindows to contents, a navigation map data source is configured to assign a window to a navigation data source and to assign another small window to a position finding data source to display a quality of GPS reception.

39. The system of claim 29, further comprising a display controller including a memory configured to store the subjects and priorities assigned to the subjects.

40. The system of claim 29, further comprising an arrangement configured to connect a set of data sources, each of the data sources configured to supply data on one subject.

41. The system of claim 29, further comprising an arrangement configured to scale data assigned to a subject for display in one of the secondary display windows.

42. The system of claim 29, further comprising an arrangement configured to visually emphasize a secondary display window when there is a change in corresponding information.

43. The system of claim 29, further comprising an arrangement configured to alter assignment of a data source from a secondary display window to the main display window when corresponding information changes.

44. The system of claim 43, wherein the arrangement configured to alter assignment is configured to perform a reverse assignment one of (a) after confirmation that a driver has taken note of altered information and (b) after a predetermined period of time has elapsed.

45. The system of claim 29, further comprising an arrangement configured to send a message to each data source which is assigned to a secondary display window, the message including a statement about a size of the secondary display window.

46. The system of claim 29, further comprising an input device configured to at least one of (a) input and (b) select subjects from the storage device of at least the highest priority and a unique priority to each subject selected.

47. The system of claim 36, wherein the size is reduceable to allow more display space for other data sources.

48. A vehicle infotainment system, comprising:
a system configured to display information in a motor vehicle, including
a display device configured to display information assigned to subjects in a main display window and in at least one secondary display window;
an storage device configured to store the subjects and an assignment of a highest priority to one of the subjects; and
an arrangement configured to generate a display on the display device to display information assigned to a highest-priority subject in the main display window and to display information assigned to a low-priority subject in one of the secondary display windows; and
data sources configured for supplying information.

49. The vehicle infotainment system of claim 48, further comprising an arrangement configured to scale the information in each of the data sources as a function of a size of a corresponding secondary display window.

50. The vehicle infotainment system of claim 48, further comprising an arrangement configured to send a message in each of the data sources to signal a change in a corresponding information with respect to the arrangement configured to generate the display.

51. A method for displaying information in a vehicle, comprising:
displaying information assigned to a highest-priority subject in a main display window;
displaying information assigned to a low-priority subject in a secondary display window;
displaying the low-priority subject in the main display window and displaying the highest-priority subject in the secondary display window one of (a) when information about the low-priority subject has changed and (b) on a basis of a corresponding input by a user.

52. The method of claim 51, further comprising:
selecting subjects by the user; and
assigning priorities by the user.

53. The method of claims 51, further comprising temporarily changing priority assignment.

54. The method of claim 51, further comprising temporarily changing priority assignment one of (a) for a predetermined period of time and (b) until confirmation that altered information has been noted is provided by the user.

55. The method of claim 51, further comprising visually emphasizing a corresponding secondary display window before a change in assignment is made when there is a change in information assigned to the low-priority subject.

56. The method of claim 51 further comprising:
sending a message containing a size of the secondary display is sent to data sources assigned to the secondary display window; and
scaling information assigned to the low-priority subject in the data sources.

57. The method of claim 56, wherein the scaling is performed so that scaled information is detectable visually by the user in the corresponding secondary display windows.

58. The method of claim 56, wherein the information is scaled so that it is reduced to one acoustic output when one of (a) a corresponding window size and (b) no window at all is available.

59. A computer program stored on a memory configured to be executed by a computer, the computer program comprising program code for displaying information in a vehicle in accordance with a method including:
displaying information assigned to a highest-priority subject in a main display window;
displaying information assigned to a low-priority subject in a secondary display window;
displaying the low-priority subject in the main display window and displaying the highest-priority subject in the secondary display window one of (a) when information about the low-priority subject has changed and (b) on a basis of a corresponding input by a user.
